(19) United States
(12) Patent Application Publication
(10) Pub. No.: US 2006/0219737 A1
(43) Pub. Date: Oct. 5, 2006

(54) Spray applicator

(76) Inventor: Bryan James Larkin, Queensland (AU)

Correspondence Address: DILWORTH & BARRESE, LLP, 333 EARLE OVINGTON BLVD., UNIONDALE, NY, 11553, US

(21) Appl. No.: 10/566,516

(22) PCT Filed: Jul. 27, 2004
(86) PCT No.: PCT/AU04/01001

§ 371 Date: Jan. 30, 2006

(30) Foreign Application Priority Data
Jul. 28, 2003 (AU) 2003903877
May 19, 2004 (AU) 2004902635
Jul. 5, 2004 (AU) 2004903640

(51) Int. Cl. B67D 5/52; B01F 13/08

(52) U.S. Cl. 222/135; 366/274

(57) ABSTRACT

A spray applicator for containing, mixing and releasing constituents of a reactive mixture, the applicator having a first containing portion for containing a first constituent of the mixture; and at least one second containing portion for releasably containing a further constituent of the mixture, wherein each at least one second containing portion is movable between a first, unmixed condition in which the second constituent is retained separately from the first constituent and a second mixing condition in which the second containing portion releases the second constituent to mix with the first constituent.

### FIELD OF THE INVENTION

The present invention relates to spray applicators and in particular to pressurised spray applicators, a particularly common example of which are aerosol paint spray cans.

### BACKGROUND ART

Spray applicators are used widely in the application of paints and adhesives.

Paints are generally made up of four components: pigment, binder, solvent/liquid carrier and additives. Varnishes, which form transparent or semi-transparent films, are made up of the last three components, with coloured varnishes containing small amounts of pigment. Spray adhesives are generally made up of a binder and a carrier, but may also include one or more additives.
Pigments, which give colour and opacity/covering power, are finely dispersed solid particles. In some cases they can be used to impart certain protective properties, eg rust prevention, and to control gloss levels.
The binder is the material that forms the film, giving protection to the substrate and keeping the pigment in place and evenly dispersed. It may be made up of a single, or a combination of polymers. The binder may be dissolved in a solvent, or in the form of an emulsion or colloidal dispersion in water. This results in solvent-borne and water-borne paints, respectively.
The solvent/liquid carrier is used to effect application of the coating. It may be water or an organic solvent, or a mixture of both, and thins the paint or varnish, allowing it to be brushed, sprayed, dipped or rolled. Once on the substrate, the solvent evaporates, leaving the dry film coating. The term ‘liquid carrier’ is preferable because the liquid may not be a true solvent for the binder.
Additives are used, in small amounts, to modify the film or paint. Examples are driers, which promote the drying time of some coatings; flow-control agents, which give a smooth surface; defoamers, which prevent the formation of bubbles that could dry in the film; and anti-skinning agents to prevent a paint from forming a ‘skin’ in the can.

It may be a long time between the manufacture of paint and the day that the tin is opened for use. The paint must therefore remain stable in the can and the ingredients must not react with one another chemically under storage conditions. Some paints do not dry by chemical reaction, but solely by the evaporation of the liquid carrier. In such cases the polymer is fully formed in the liquid state and does not change chemically on drying.

Paints that “dry” by chemical reaction are linear (or lightly branched) polymers or simple monomers that react on drying or curing to form an insoluble cross-linked network. This can occur in two ways:
Reaction with oxygen or water in the air. Some paints such as oil-based decorative gloss and eggshell finishes contain natural or synthetic oils containing unsaturated bonds. Oxygen from the air can react to produce free radicals and facilitate polymerisation. Some paints containing isocyanate groups (—NCO) can react with water in the air by condensation polymerisation. Air must be excluded from the can by a tight-fitting lid, or a skin can form in the can. Chemical reaction with the air is relatively slow at room temperature due to the slowing effect of the thickening film. Reaction will continue long after the coating appears dry, changing the properties of the film.
Reaction between the components of the coating. The reactive species can be kept apart until the coating needs to be applied, or the components chosen so that they only react at high temperatures. In the former case, ‘two-pack’ paints have a limited ‘pot life’ before they react to produce an unusable viscosity. Examples are epoxy-amine and isocyanate-polyol systems. Stoving enamels and powder coatings are examples in which the reaction is effected by heat.

In two-pack systems, also known as epoxy systems, the paint or glue is particularly hard or strong as the two-pack system contains a curing or hardening agent so that when the two constituents are mixed together, there is a chemical reaction between the constituents rather than a simple “drying or evaporation” system of a single pack.

Two-pack systems are rarely, if ever sold in a spray applicator due to the difficulty in controlling the mixing of the two constituents and also the limited “pot-life” once the two constituents are mixed.

For example, in an amine-cured, two-pack epoxy product, active sites on the epoxy (epoxide rings on part A) react with active sites on the curing agent (amine groups on Part B) to form a chemical bond. For any given formulation, there will be a certain number of these sites available, and the objective is to try and match these exactly so there is no shortage or excess.

If too much curing agent is used (too many amine sites), it will indeed cure the epoxy, however there will be left over amine that will remain reactive to other substances that it comes into contact with, e.g. moisture, air, and other chemicals. If, conversely, not enough is used (too many epoxy sites), the epoxy won't be fully cured and will remain soft and also vulnerable to chemical attack. The only way to achieve a hard, strong, chemical resistant and abrasion resistant product is to have these quantities match up precisely. The problem is exacerbated in spray application systems as the container holding one or the other constituent is pressurized to allow spraying of the mixture. Due to its sealed nature, the user can never be certain that the required degree of mixing has occurred. This is also a problem in simpler one-pack systems when the carrier and the other constituents separate while settling.

In the prior art systems, mixing of constituents in a sealed applicator is generally accomplished by shaking the can vigorously before use. However, as soon as the shaking stops, the constituents begin to settle sometimes quite quickly. This also occurs when spraying ceases to prepare of adjust the workpiece being sprayed.

One prior art method of enhancing the mixing was to provide a mixing bead or similar. The bead is simply a physical obstruction that enhances mixing. It would be advantageous to have a spray applicator which can hold and mix the contained constituents of a multipart mixture more effectively and thereby reduce or at least partially overcome some of the problems above.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a spray applicator, which may at least partially overcome at least one of the abovementioned disadvantages or provide the consumer with a useful or commercial choice.

In one form, the invention resides in a spray applicator for containing, mixing and releasing constituents of a reactive mixture, the applicator having
i. a first containing portion for containing a first constituent of the mixture and;
ii. at least one second containing portion for releasably containing a further constituent of the mixture,
   wherein each at least one second containing portion is operable between a first, unmixed condition in which the second constituent is retained separately from the first constituent and a second mixing condition in which the second containing portion releases the second constituent to mix with the first constituent.

The invention may be used to contain, mix and disperse any multipart mixture. It is particularly directed towards use with multipart reactive mixtures, particularly coatings such as two-pack (epoxy) paints, or resins and epoxy adhesives. The further constituent may be a catalyst or chemical trigger to react with the first constituent to form a settable mixture. The applicator may be used with any mixture having a propellant and a product, but is particularly suited to mixtures in which the constituents react with each other and must therefore be maintained separately until actual use.

The applicator will generally be a pressurised spray applicator commonly referred to generally as an aerosol. An aerosol is generally made up of several components as illustrated in FIG. 1, namely:

An aerosol can or container;

The product;

The propellant;

A valve;

A dip tube; and

An actuator

The spray applicator of the invention may have above components.

The propellant may be a fluid that boils well below room temperature and a product, being a fluid that boils at a much higher temperature. The product is the substance that a user actually desires to disperse and the propellant is the means of getting the product out of the can. Both fluids are generally stored in a sealed metal can.

There are two main ways to configure an aerosol system and either may be used according to the invention. In the simpler design, liquid product is poured into the container, the container is then sealed, and then a gaseous propellant is pumped into the container through the valve system. The gas may be pumped in at high-pressure, so it pushes down on the liquid product. This system is illustrated in FIG. 1.

In this container, a plastic tube runs from the bottom of the can up to a valve system at the top of the can. The valve generally has a small, depressible head piece, with a narrow channel running through it. The channel runs from an inlet near the bottom of the head piece to a small nozzle at the top. A spring pushes the head piece up, so the channel inlet is blocked by a tight seal.

When the head piece is pressed down, the inlet slides below the seal, opening a passage from the inside of the can to the outside. The high-pressure propellant gas drives the liquid product up the plastic tube and out through the nozzle. The narrow nozzle serves to atomize the flowing liquid which forms a fine spray.

In a more popular system, the propellant is a liquefied gas and the propellant generally takes liquid form when it is highly compressed, even if it is kept well above its boiling point.

Since the product is liquid at room temperature, it is simply poured in before the can is sealed. The propellant, on the other hand, must be pumped in under high pressure after the can is sealed. When the propellent is kept under sufficiently high pressure, it cannot expand into a gas. It stays in liquid form as long as the pressure is maintained.

As is illustrated in FIG. 2, the actual can design in a liquefied-gas system is exactly the same as in the compressed-gas system. However the function of the system is slightly different when actuated.

When the valve is open, the pressure on the liquid propellant is reduced. With less pressure, the propellant begins to boil. Particles break free, forming a gas layer at the top of the container. This pressurized gas layer pushes the liquid product, as well as some of the liquid propellant, up the tube to the nozzle. Some containers, such as spray-paint cans, have a ball bearing inside. If you shake the can, the rattling ball bearing helps to mix up the propellant and the product, so the product is pushed out in a fine mist.

When the liquid flows through the nozzle, the propellant rapidly expands into gas and atomises the product.

Spray applicators such as the one disclosed by the present invention are generally aerosol cans and the first containing portion may preferably be the can itself which is usually made from tinplated steel, or aluminium.

The first containing portion may be what is generally termed a can which is typically made up of three components—a top containing the valve opening, a body and a bottom. Three piece cans are generally manufactured from tinplate. A two piece can may also be used as these are also known. Aluminium cans may be made from single piece of aluminium metal.

The material used to make aerosol cans, apart from aluminium, is generally low carbon mild steel sheet, coated with tin applied by electro-deposition. The thickness of the sheet used to make aerosol cans will vary, depending on the size of the can, the pressure specification, and whether it is for can bodies or end components. For can bodies the thickness will generally range from 0.18 mm to 0.25 mm, and for tops/bottoms they will generally be 0.28 mm to 0.43 mm.

Generally, there will always be some head space in the can which does not contain liquid. Because an aerosol is under pressure there must be sufficient space for the propellant to occupy, under all likely conditions. The amount of head space may be greater when a compressed gas, such as air, is used, as these propellants operate at higher pressures than those for liquefied propellants.

The top portion of the can is generally frustoconical with an opening at the top for the valve and dip tube arrangement. The body of the can is generally cylindrical but may be of any shape. In most aerosol cans, the bottom is hemispherical or torispherical and curves inward. This may serve two functions:

Firstly, the shape may strengthen the structure of the can. With this shape, most of the force applied at the top of the curved metal is distributed to the sturdy edges of the can. The bottom of the can may be provided with an opening therein. The opening may suitably allow communication from outside the can to the interior of the can.

The opening may be provided with an activation means for moving the second containing portion between the first, unmixed condition in which the second constituent is retained separately from the first constituent and the second mixing condition. The opening will generally be suitably sealed in the bottom of the can such that any substance within the can cannot escape from the can through the opening but must exit the can through the nozzle provided.

The shape may also make it easier to use up all the product. With a curved bottom design, the last bit of product collects in the small area around the edges of the can. This makes it easier to empty almost all of the liquid.

As stated above, the first containing portion may preferably be the can itself. The first constituent may suitably be the product to be dispersed or more preferably, a component of a reactive mixture. The first constituent may be a single component or more preferably, a mixture of more than one ingredient itself.

Preferably, the second containing portion may be located toward a lower portion of the first containing portion. The second containing portion will contain a further constituent of the mixture. The further constituent is preferably a further component of a reactive mixture. As with the first constituent, the further constituent may be a single component or more preferably, a mixture of more than one ingredient itself.

In a particularly preferred embodiment of this aspect of the invention, wherein the first containing portion is a can, the second containing portion may suitably be associated with the bottom of the can.

The second containing portion may suitably be a pouch or sac and it may be located abutting or resting against the bottom of the can. The pouch or sac may suitably be a flattened annular shape. The pouch or sac may also have an opening provided in a central portion. A locating portion to assist with the location and preferably retention of the pouch or sac in position may be provided. The locating portion may suitably be a locating projection or a depression into which the pouch or sac may sit. The opening in the pouch or sac may be provided in order to fit over a locating projection associated with either a wall of the bottom of the first containing portion. Once the pouch or sac is located relative to the locating portion, an expulsion member may be associated with the pouch or sac.

The bag or sac may be rupturable. Rupturing the pouch or sac to release the further constituent may be accomplished by any method. However, one particularly preferred method of rupturing the pouch or sac may be using the expulsion member to rupture the pouch or sac.

Suitably, the expulsion member may be mounted relative to the locating projection. The expulsion member may be at least partially arcuate in shape to correspond at least partially to the shape of the bottom of the can. The expulsion member is suitably approximately a similar size to the size of the second containing portion. In this way the expulsion member may exert a substantial force on the second containing portion and this may increase the effectiveness of the expulsion of the further constituent.

The expulsion member may be associated with the activation means to move the expulsion member between a first condition in which the expulsion member is spaced from the bottom of the can, generally with the pouch or sac between the expulsion member and the bottom of the can, and a second condition in which the expulsion member is forced toward the bottom of the can, generally with the pouch or sac between the expulsion member and the bottom of the can, thus forcing the expulsion of the further constituent from the pouch or sac.

The locating portion may be a tubular portion extending upwardly from the bottom of the can. The activation means provided according to a particularly preferred form of this aspect of the invention may include the expulsion member having a projecting portion extending into the tubular locating portion. The projecting portion may suitably be threaded. A correspondingly threaded, externally accessible gripping means may be provided and may be associated with the projecting portion. The gripping means may suitably not extend from the bottom of the can a distance which will affect the balance of the can when resting in an upright configuration.

Rotation of the griping means may result in the projecting portion being drawn towards the bottom of the can, thus moving the expulsion member towards the bottom of the can. This may exert pressure or compression upon the pouch or bag and the fluid therein and force the pouch or bag from the first condition into the second condition. This compression may result in the rupture of the pouch or bag and the release of the second constituent into the first containing portion. Alternatively, with the rupture of the pouch or bag, the first constituent may enter the second containing portion.

This expulsion member may thereby move the pouch or sac between a first, unmixed condition in which the second constituent is retained separately from the first constituent and a second mixing condition in which the second containing portion releases the second constituent to mix with the first constituent.

As stated above, this is only one of the means which may be used and other means may be used with equal effect. For example, the pouch or sac could be provided at least partially between two squeezing members with an opening provided between them to squeeze the pouch or sac and rupture it. A threaded means may be provided to draw the pouch or sac through the opening and thereby compress the fluid in the pouch or sac to the point where the pouch or sac is ruptured. The movement of the expulsion member may be a single movement as opposed to threaded movement. Levers may be used instead of screwing movement of the gripping means. The second containing portion need not be a pouch or bag.

In a second form, the invention resides in a spray applicator having,
i. At least one container for containing at least one fluid to be sprayed, one of the containers having an internal agitation means to agitate the at least one fluid, and
ii. drive means separate from but engageable with the agitation means, the drive means adapted to engage the agitation means magnetically to drive the agitation means within the container.

The fluid to be sprayed may be a mixture of components. The container may also contain a propellant to assist or forcibly expel the fluid to be sprayed from the container. The container and drive means configuration as described herein may be provided in combination with the first aspect of the invention as well.

The container may generally be a can as described above with reference to the first aspect of the invention and may be of either the compressed gas type or the liquefied gas type referred to above.

The internal agitation means for agitating the at least one fluid may have any configuration adapted to achieve agitation. The agitation means may also be a mixing means. The at least one fluid may have a single component or more preferably, may be a mixture of more than one component itself. The agitation means may also function to mix more thoroughly, a multi-component reactive mixture such as that described above with reference to the first aspect of the invention.

The agitation means in its most preferred form may be an impeller. Alternatively, less preferred but still viable alternatives for the agitation means may be a mixing bead similar to that found in conventional aerosol cans, or reciprocating agitation means.

Where provided, an impeller may be rotatable within the can and generally rotates about an axis which is parallel, if not, in line with, a longitudinal axis of the can. The impeller will suitably be mounted in a lower portion of the can and most preferably adjacent the bottom of the can. The impeller may be mounted relative to a mount, generally a locating portion. The locating portion may be a projection extending upwardly from the bottom of the can or it could equally be a depression or the like.

Suitably, the impeller may be mounted relative to the locating projection. Any mounting of the impeller will typically be centrally located in a radial direction so as to provide well distributed agitation. The impeller may be at least partially arcuate in shape to correspond at least partially to the shape of the bottom of the can. The impeller is suitably approximately a similar size to the size of the bottom of the can.

The impeller will typically have one or more blades in order to increase the efficiency of the agitation. The one or more blades may have a particular pitch to promote or effect multi-directional agitation within the can. According to a particularly preferred embodiment, the impeller may comprise a body, with a passageway extending through the body to mount relative to the locating projection, and at least one turbine surface which is angled relative to the longitudinal direction of the can.

The body portion may suitably be at least partially arcuate in shape to correspond at least partially to the shape of the bottom of the can.

The drive means will be provided externally of the container and the agitation means provided inside the container. This allows the container to be completely sealed apart from the nozzle allowing exit of the at least one fluid to be sprayed, but still provide an arrangement which is adapted to allow thorough agitation of the at least one fluid to be sprayed.

The drive means may preferably be a rotor or the like. The rotor will suitably be at least partially shaped to correspond at least partially to the shape of the bottom of the can. The rotor may be at least partially annular with a substantially centrally located opening therethrough. The annular part of the rotor may be arcuate in cross-section. The opening may be of any size, for example, the opening may be such that the gripping means at the bottom of the can as described relative to the first aspect of the invention may be accommodated.

The rotor will suitably be mounted closely spaced from the bottom of the can with minimal separation between the rotor and an external surface of the bottom of the can. The rotor will typically be centrally located in a radial direction to correspond with the internally mounted agitation means.

The rotor, as its name suggests, will typically rotate. The rotation may be provided by any means and alternatives may be a small motor or the like, a manually driven rotation by crank or handle or the like, or even using an energy storing device such as a coiled spring which can be wound and released.

According to a particularly preferred embodiment of the invention, there may be a housing provided with an opening therein. The opening will suitably be sized to receive at least the bottom of the can and preferably a lower portion of the can. The opening may be in the form of a recess defined by at least one sidewall which may further support the can.

Suitably, the rotor may be associated with the recess. Preferably, the rotor may be positioned in the recess such that when the can is placed into the recess, the rotor may be closely spaced from the bottom of the can. The rotor may then function to drive an agitation means whether it is in the form of an impeller or a bead or the like. The rotor may be associated with a means to rotate the rotor such as a motor or the like. Where a motor is provided, the motor may have an appropriate power source associated with it such as batteries or a connection to a mains power source. There may be ancillary means also associated with the housing and rotor such as operating switches and the like.

As stated above, the drive means may alternatively be a reciprocating drive means and it may be associated with a reciprocating agitation member. The reciprocating agitation member may be as simple as a member which reciprocates inside the container. It may also rotate whilst reciprocating. For example, a reciprocating member may comprise a body, and at least one turbine surface which is angled to impart a rotational force to the cleaning device as the member reciprocates inside the can.

The drive means, irrespective of its form, is separate from the agitation means but engages the agitation means magnetically. Therefore, the drive means and the agitation means have magnetic properties, that is, they either are, or are affectable using one or more magnets.

The magnetic properties of the drive means and the agitation means are preferably attraction or repulsion to a magnet. The drive means and the agitation means may be, or include one or more magnets but they need not. One of the means, for example, may be or include a ferromagnetic material which is attracted to a magnet. Suitably, both the agitation means and the drive means may include at least one magnet. The magnets may be so arranged relative to each means that even when separated by the bottom of the can (which will generally be metal), the magnets on the respective means may still engage each other. The one or more magnets associated with the drive means will suitably engage the one or more magnets associated with the agitation means to cause sympathetic movement of the agitation means when the drive means moves. The magnets may be attached to or partially embedded into the rotor. As like poles repel each other, the magnets of the rotor may be positioned so that the pole closest to the bottom of the can is opposite that of the magnets of the impeller.

There are various configurations of agitation means and drive means in order to achieve magnetic engagement. Some of these are magnet-metal, magnet-magnet or superconductive materials may also be used.

In a third form, the invention resides in a spray applicator for containing, mixing and releasing constituents of a reactive mixture, the applicator having
i. a container for containing a first constituent of the mixture;
ii. activation means to release the first constituent from the container;
iii. a container closure engageable with the container, the container closure comprising
   a. a fluid opening through which fluid can flow, the fluid opening in fluid communication with the container,
   b. at least one reservoir for containing a further constituent in fluid communication with the fluid opening, and
   c. a mixing valve to control the flow of the further constituent from the at least one reservoir,
      wherein upon operation of the activation means the further constituent is drawn from the at least one reservoir by the flow of the first constituent and the further constituent mixes with the first constituent, prior to exiting the container closure.

The container may generally be a can as described above with reference to the first and/or second aspect of the invention and may be of either the compressed gas type or the liquefied gas type referred to above.

The invention may be used to contain, mix and disperse any multipart mixture. It is particularly directed towards use with multipart reactive mixtures, particularly coatings such as two-pack (epoxy) paints, or resins and epoxy adhesives. The further constituent may be a catalyst or chemical trigger to react with the first constituent to form a settable mixture. The applicator may be used with any mixture having a propellant and a product, but is particularly suited to mixtures in which the constituents react with each other and must therefore be maintained separately until actual use.

The container may preferably be a can. The first constituent may suitably be the product to be dispersed or more preferably, a component of a reactive mixture. The first constituent may be a single component or more preferably, a mixture of more than one ingredient itself.

Preferably, the further constituent is a further component of a reactive mixture. As with the first constituent, the further constituent may be a single component or more preferably, a mixture of more than one ingredient itself. It could be a spreading aid or a finishing product.

In a particularly preferred embodiment of the container, a plastic tube runs from the bottom of the can up to an activation system at the top of the can, the activation system generally including an operating valve. The operating valve generally has a small, depressible head piece, with a narrow channel running through it. The channel runs from an inlet near the bottom of the head piece to a small nozzle at the top. A spring pushes the head piece up, so the channel inlet is blocked by a tight seal.

According to this preferred embodiment, when the head piece is pressed down, the inlet slides below the seal, opening a passage from the inside of the can to the outside. The high-pressure propellant gas drives the liquid product up the plastic tube and out through the nozzle. The narrow nozzle serves to atomize the flowing liquid which forms a fine spray.

In an alternative container and system, the propellant may be a liquefied gas and the propellant generally takes liquid form when it is highly compressed, even if it is kept well above its boiling point.

Since the product is liquid at room temperature, it may be simply poured in before the can is sealed. The propellant, on the other hand, is generally pumped in under high pressure after the can is sealed. When the propellent is kept under sufficiently high pressure, it cannot expand into a gas. It stays in liquid form as long as the pressure is maintained.

According to this preferred embodiment, when the operating valve is open, the pressure on the liquid propellant is reduced. With less pressure, the propellant begins to boil. Particles break free, forming a gas layer at the top of the container. This pressurized gas layer then generally pushes the liquid product, as well as some of the liquid propellant, up the tube to the nozzle.

The container closure may be adapted to allow mixing of the first constituent and a further constituent.

The fluid opening is preferably associated with the mixing valve. The mixing valve may be adapted to substantially seal the reservoir in a first position and allow the further constituent to flow in a second position. The valve may also be capable of adjustment to adjust the rate at which the further constituent flows from the at least one reservoir.

The container closure may preferably be engageable with the container holding the first constituent in any way. It is preferred that the container closure may be removable from the container in order to allow replacement of the container closure. In this manner, different container closures having different further constituents may be used with a single container.

The container closure may preferably be at least partially see-through. In a particularly preferred embodiment, the container closure may only be see-through in the region of the reservoir containing the further constituent, in order to ascertain the amount of further constituent remaining in the reservoir.

The container closure may typically form a fluid type seal with the container. The fluid type seal maybe enhanced by the use of sealing means such as a rubber washer or the like interposed between the container closure and the container. The container closure may have a grip enhancing means on an outer portion to allow users to attach and detach the container closure from the container. The grip enhancing means may suitably be adapted for manual operation.

The container closure may suitably be manufactured from a strong but light material, for example plastic. Most preferably, the container closure may be manufactured from polyethylene terephthalate (PET). The container closure may suitably be injection moulded but may be manufactured according to any appropriate method.

The two constituents may preferably mix in a turbulent manner and the mixing may be substantially instantaneous. It is particularly preferred that the mixing between the two fluids take place with little or no chance of back flow of the mixture or the further constituent into the container holding the first constituent. This aspect may minimise the chance of mixing of the two constituents when no mixing is desired. Means for preventing backflow, such as a non-return valve may be provided.

Suitably, the container closure may be capable of allowing the first constituent in the container access to the fluid opening without mixing with the further constituent when the mixing valve is fully closed. In this way, if the user desires the first constituent alone, the container closure may be adapted to allow this. Generally, a pipe links the fluid opening and the reservoir.

It is particularly preferred that the first constituent held in the container may be a base fluid and the further constituent may be a concentrated fluid.

The reservoir contains the further constituent, which is most preferably a second fluid. A single filled reservoir may be capable of mixing with more than the amount of first constituent contained in a container. The reservoir may typically be integrally formed with the container closure. The reservoir may also be refillable and/or drainable. The reservoir may suitably be designed to drain efficiently and/or easily when mixing with the first constituent or simply to empty the reservoir. There may be a bleed valve or similar to allow the easy draining of the reservoir. The reservoir may be removable from the container closure and replaceable.

The reservoir may suitably be manufactured from the same or a similar material to the other components in the container closure or container, or alternatively may be manufactured from a different material.

### BRIEF DESCRIPTION OF THE DRAWINGS

Various embodiments of the invention will be described with reference to the following drawings, in which:

FIG. 1 is a partially sectional view of a prior art compressed gas aerosol can.

FIG. 2 is a partially sectional view of a prior art liquefied gas aerosol can.

FIG. 3 is a sectional elevation view of a preferred embodiment of a spray applicator according to a first aspect of the present invention.

FIG. 4 is a detailed sectional elevation view of a lower portion of the spray applicator illustrated in FIG. 3, with the second containing portion in the unmixed condition.

FIG. 5 is a detailed sectional elevation view of a lower portion of the spray applicator illustrated in FIG. 3, with the second containing portion in the mixing condition.

FIG. 6 is a sectional elevation view of a preferred embodiment of a spray applicator according to a first aspect of the present invention with the drive means illustrated.

FIG. 7 is a sectional elevation view of a preferred embodiment of a spray applicator according to a second aspect of the present invention.

FIG. 8 is a sectional elevation view of an upper portion of a preferred embodiment of a spray applicator according to a third aspect of the present invention, with the mixing valve in the closed condition.

FIG. 9 is a sectional elevation view of an upper portion of a preferred embodiment of a spray applicator according to a third aspect of the present invention, with the mixing valve in the open or mixing condition.

### DETAILED DESCRIPTION OF THE INVENTION

According to a first aspect of the present invention, a spray applicator is provided.

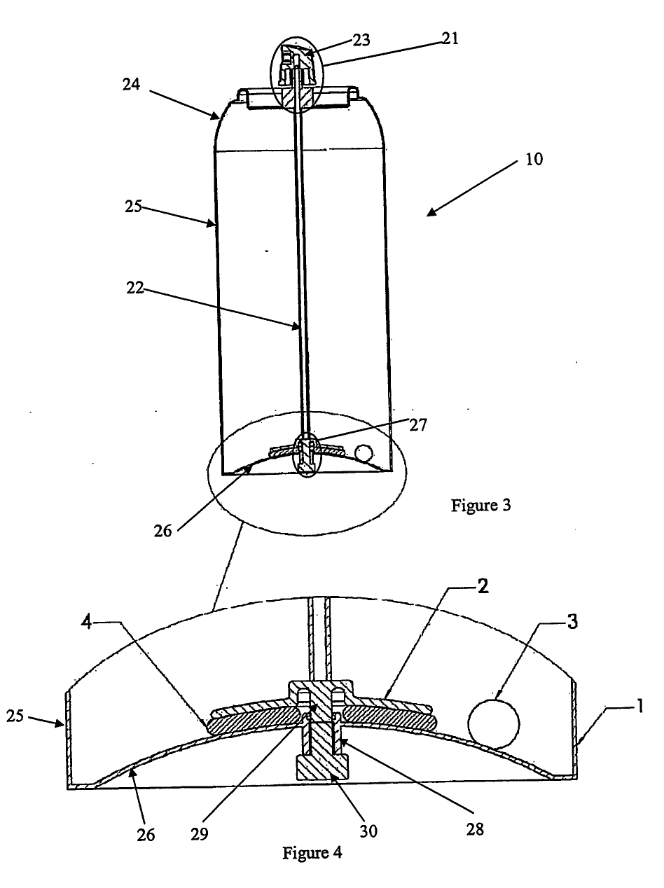

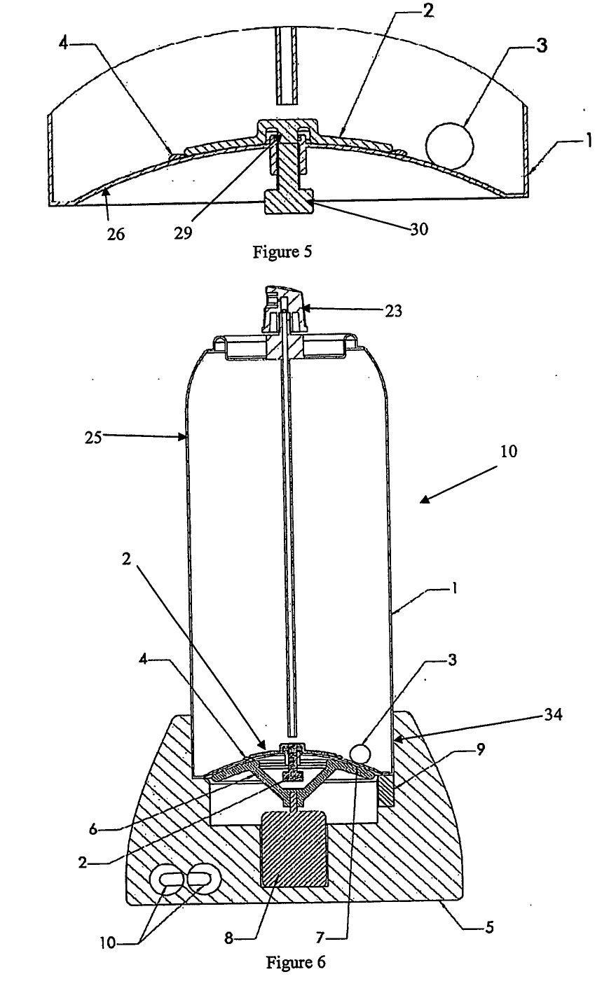

A preferred embodiment of the spray applicator 10 of the first aspect of the invention is illustrated in FIGS. 3 to 6. The applicator 10 has a can 1 for containing a first constituent of the mixture and a pouch or sac 4 for releasably containing a further constituent of the mixture. The pouch or sac 4 is movable between a first, unmixed condition in which the second constituent is retained separately from the first constituent and a second mixing condition in which the pouch or sac 4 releases the second constituent to mix with the first constituent.

The invention may be used to contain, mix and disperse any multipart mixture. It is particularly directed towards use with multipart reactive mixtures, particularly coatings such as two-pack (epoxy) paints, or resins and epoxy adhesives. The further constituent may be a catalyst or chemical trigger to react with the first constituent to form a settable mixture. The applicator 10 can be used with any mixture having a propellant and a product, but is particularly suited to mixtures in which the constituents react with each other and must therefore be maintained separately until actual use.

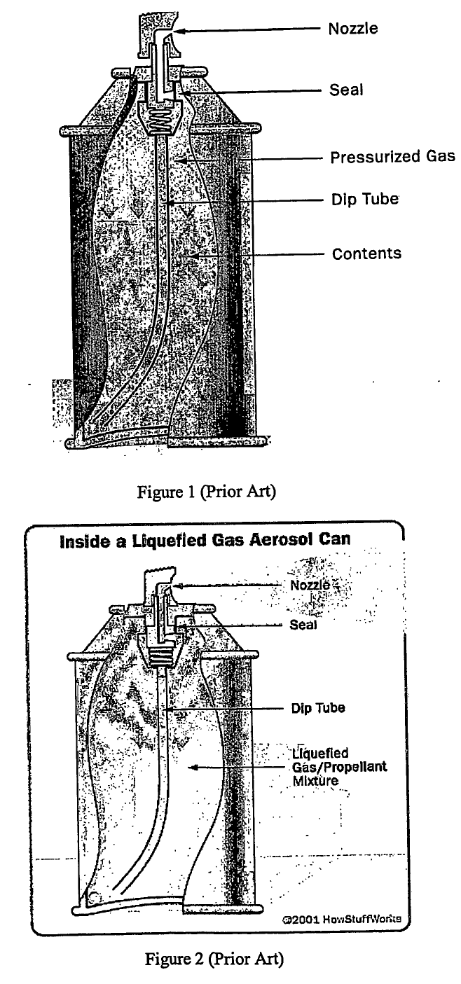

The applicator 10 of the preferred embodiments is a pressurised spray applicator commonly referred to generally as an aerosol. An aerosol is generally made up of several components as illustrated in FIG. 1, namely:

An aerosol can or container;

The product;

The propellant;

An operating valve;

A dip tube; and

An actuator

The spray applicator of the invention illustrated in the Figures has the above components but the operating valve and the actuator are generally referred to using a single reference numeral 21.

There are two main ways to configure an aerosol system, a compressed gas system and a liquefied gas system and either may be used according to the invention. Both systems have the same components of the applicator 10.

In the can 1, a plastic dip tube 22 runs from the bottom of the can 1 up to a valve system 21 at the top of the can 1. The valve system 21 generally has a small, depressible head piece 23, with a narrow channel running through it. The channel runs from an inlet near the bottom of the head piece to a small nozzle at the top. A spring pushes the head piece up, so the channel inlet is blocked by a tight seal.

Spray applicators 10 such as the one disclosed by the present invention are generally aerosol cans 1 and the first containing portion is the can 1 itself which is usually made from tinplated steel, or aluminium.

The can 1 is typically made up of three components—a top 24 containing the valve system 21, a body 25 and a bottom 26. Three piece cans 1 are generally manufactured from tinplate.

The thickness of the sheet used to make aerosol cans 1 will vary, depending on the size of the can, the pressure specification, and whether it is for can bodies or end components. For can bodies the thickness will generally range from 0.18 mm to 0.25 mm, and for tops/bottoms they will generally be 0.28 mm to 0.43 mm.

The top 24 of the can 1 is frustoconical with an opening at the top for the valve system 21 and dip tube 22. The body 25 of the can 1 is cylindrical. The bottom 26 is torispherical and curves inward.

The bottom 26 of the can 1 is provided with an opening therein. The opening allows communication from outside the can 1 to the interior of the can 1.

The opening is provided with an activation means 27 for moving the pouch or sac 4 between the first, unmixed condition in which the second constituent is retained separately from the first constituent and the second mixing condition. The opening is sealed in the bottom 26 of the can 1 such that any substance within the can 1 cannot escape from the can 1 through the opening but must exit the can through the valve system 21 provided.

With a curved bottom 26 design, the last bit of product collects in the small area around the edges of the can 1. This makes it easier to empty almost all of the liquid.

The first constituent is either the product to be dispersed or more preferably, a component of a reactive mixture.

The pouch or sac 4 is located toward a lower portion of the can 1. The pouch or sac 4 contains a further constituent of the mixture. The further constituent is preferably a further component of a reactive mixture. As with the first constituent, the further constituent may be a single component or more preferably, a mixture of more than one ingredient itself.

The pouch or sac 4 is located abutting or resting against the bottom 26 of the can 1. The pouch or sac 4 is a flattened annular shape with an opening provided in a central portion. A locating portion 28 to assist with the location and retention of the pouch or sac 4 in position is provided. The locating portion is a locating projection 28. The opening in the pouch or sac 4 is provided in order to fit over the locating projection 28 associated with the bottom 26 of the can 1. Once the pouch or sac 4 is located relative to the locating portion 28, an expulsion member 2 is associated with the pouch or sac 4.

The bag or sac 4 is rupturable. The expulsion member 2 is mounted relative to the locating projection 28. The expulsion member 2 is partially arcuate in shape to correspond to the shape of the bottom 26 of the can 1. The expulsion member 2 is approximately similar in size to the size of the pouch or sac 4. In this way the expulsion member 28 can exert a substantial force on the pouch or sac 4 and increase the effectiveness of the expulsion of the further constituent.

The expulsion member 4 is associated with the activation means 27 to move the expulsion member 28 between a first condition in which the expulsion member 4 is spaced from the bottom 26 of the can 1, with the pouch or sac 4 between the expulsion member 28 and the bottom 26 of the can 1, and a second condition in which the expulsion member 28 is forced toward the bottom 26 of the can 1, with the pouch or sac 4 between the expulsion member 2 and the bottom 26 of the can 1, thus forcing the expulsion of the further constituent from the pouch or sac 4.

The locating portion 28 is a tubular portion extending upwardly from the bottom 26 of the can 1. The activation means 27 provided according to a particularly preferred form of this aspect of the invention includes the expulsion member 2 having a projecting portion 29 extending into the tubular locating portion 28. The projecting portion 29 is threaded and a correspondingly threaded, externally accessible gripping means 30 is provided and is associated with the projecting portion 29. The gripping means 30 does not extend from the bottom 26 of the can 1 a distance which will affect the balance of the can 1 when resting in an upright configuration.

Rotation of the griping means 30 results in the projecting portion 29 being drawn towards the bottom 26 of the can 1, thus moving the expulsion member 2 towards the bottom 26 of the can 1. This exerts pressure or compression upon the pouch or sac 4 and the fluid therein and forces the pouch or sac 4 from the first condition into the second condition. This compression also results in the rupture of the pouch or sac 4 and the release of the second constituent into the can 1.

This expulsion member 2 thereby moves the pouch or sac 4 between a first, unmixed condition in which the second constituent is retained separately from the first constituent and a second mixing condition in which the pouch or sac 4 releases the second constituent to mix with the first constituent.

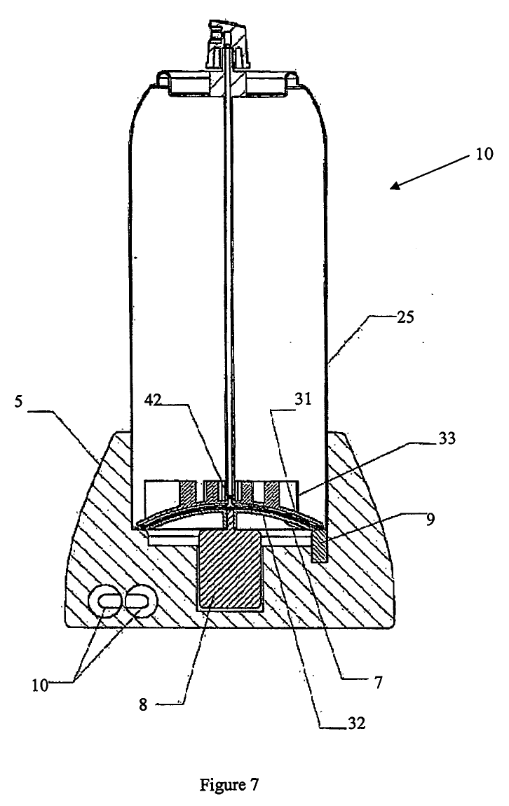

In a preferred embodiment of a second aspect of the invention, a spray applicator 10 as illustrated in FIG. 7 is provided. The applicator 10 has a can 1 for containing a fluid to be sprayed, the container 1 having an internal impeller 31 to agitate the fluid. The applicator10 also has a rotor 6, 32 separate from but engageable with the impeller 31, the rotor 6, 32 adapted to engage the impeller 31 magnetically to drive the impeller 31 within the can 1.

The fluid to be sprayed can be a mixture of components. The can 1 will generally contain a propellant to assist or forcibly expel the fluid to be sprayed from the can. The can 1 and rotor 6, 32 configuration as described herein may be provided in combination with the first aspect of the invention as well as illustrated in FIG. 6.

The can used in the preferred embodiment of the second aspect of the invention is similar to that described above with reference to the first aspect of the invention and may be of either the compressed gas type or the liquefied gas type referred to above.

The internal impeller 31 for agitating the fluid may have any configuration adapted to achieve agitation and may be a mixing means. The fluid may have a single component or more preferably, may be a mixture of more than one component itself. The agitation means may also function to mix more thoroughly, a multi-component reactive mixture such as that described above with reference to the first aspect of the invention.

The impeller 31 is illustrated in FIG. 7 but a mixing bead 3 similar to that found in conventional aerosol cans an example of which is illustrated in FIG. 6, may be used as the agitation means.

The impeller 31 is rotatable within the can 1 about an axis which is parallel, if not in line with, a longitudinal axis of the can 1. The impeller 31 is mounted adjacent the bottom 26 of the can 1. The impeller 31 is mounted relative to a mount, generally a locating portion 28. The locating portion 28 is a projection extending upwardly from the bottom 26 of the can 1.

The impeller 31 is mounted relative to the locating projection 28. The impeller 31 is centrally located in a radial direction so as to provide well distributed agitation. The impeller 31 is partially arcuate in shape to correspond at least partially to the shape of the bottom 26 of the can 1. The impeller 31 is approximately a similar size to the size of the bottom 26 of the can 1.

The impeller 31 has one or more blades 33 in order to increase the efficiency of the agitation. The blades 33 have a particular pitch to promote or effect multi-directional agitation within the can 1.

The rotor 6, 32 is provided externally of the can 1 and the impeller 31 is provided inside the can 1. This allows the can 1 to be completely sealed apart from the nozzle and valve system 21 allowing exit of the fluid to be sprayed, but still provide an arrangement which is adapted to allow thorough agitation of the fluid to be sprayed.

The rotor 6, 32 is at least partially shaped to correspond at least partially to the shape of the bottom 26 of the can 1. The rotor 6, 32 is at least partially annular with a substantially centrally located opening therethrough. The annular part of the rotor 6, 32 is arcuate in cross-section. The opening can be of any size, for example, the opening can be such that the gripping means 30 at the bottom of the can 1 as described relative to the first aspect of the invention may be accommodated as illustrated in FIG. 6.

The rotor 6, 32 is mounted closely spaced from the bottom 26 of the can 1 with minimal separation between the rotor 6, 32 and an external surface of the bottom 26 of the can 1. The rotor 6, 32 is centrally located in a radial direction on a mount 42 to correspond with the internally mounted impeller 31.

The rotation of the rotor 6, 32 is provided by a small motor 18. A housing 15 is provided with a recess 34 therein. The recess 34 is sized to receive the bottom 26 of the can 1 and a lower portion of the can 1. The recess 34 defined by a sidewall which may further support the can 1.

The rotor 6, 32 is positioned in the recess 34 such that when the can 1 is placed into the recess 34, the rotor is closely spaced from the bottom 26 of the can 1. The rotor 34 functions to drive the impeller 31 or a bead 3 or the like. The rotor is associated with a means to rotate the rotor such as a motor 18. The motor 18 has an appropriate power source associated with it such as batteries 20. An operating switch is also provided 19.

The rotor 6, 32 is separated from the impeller by the bottom 26 of the can 1 but engages the impeller 31 magnetically. The rotor 6, 32 and the impeller 31 have magnetic properties, that is, they either are, or are affectable using one or more magnets.

The magnetic properties of the rotor 6, 32 and the impeller 31 are preferably attraction or repulsion to a magnet 7. Both the rotor 6, 32 and the impeller 31 include at least one magnet 7. The magnets 7 may be so arranged relative to each means that even when separated by the bottom of the can (which will generally be metal), the magnets 7 on the respective means can still engage each other. As like poles repel each other, the magnets 7 of the rotor 6, 32 are positioned so that the pole closest to the bottom of the can is opposite that of the magnets of the impeller 31.

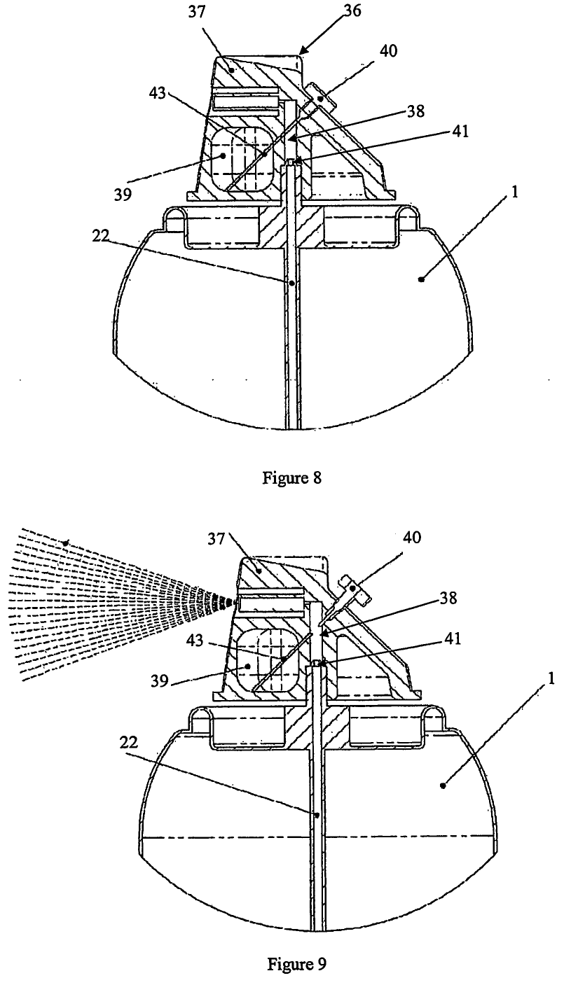

In a preferred embodiment of a third aspect of the invention, a spray applicator 10 as illustrated in FIGS. 8 and 9 is provided. The applicator 10 has a can 1 for containing a first constituent of the mixture, and activation means 36 to release the first constituent from the can. The applicator also includes a container closure 37 engageable with the can 1. The container closure 37 has a fluid opening 38 through which fluid can flow, the fluid opening 38 in fluid communication with the can 1, a reservoir 39 for containing a further constituent in fluid communication with the fluid opening 38, and a mixing valve 40 to control the flow of the further constituent from the reservoir 39. Generally, a pipe 43 links the fluid opening and the reservoir 39. Upon operation of the activation means 36, the further constituent is drawn from the reservoir 39 by the flow of the first constituent and the further constituent mixes with the first constituent, prior to exiting the container closure 37. When the activation means 36 is triggered, the first fluid can exit the can1 and as it passes the reservoir 39, it draws the second fluid from the reservoir to mix with the first fluid.

The can 1 is similar to that described above with reference to the first and/or second aspect of the invention and may be of either the compressed gas type or the liquefied gas type referred to above.

This aspect of the invention may be used to contain, mix and disperse any multipart mixture. It is particularly directed towards use with multipart reactive mixtures, particularly coatings such as two-pack (epoxy) paints, or resins and epoxy adhesives. The further constituent may be a catalyst or chemical trigger to react with the first constituent to form a settable mixture. The applicator may be used with any mixture having a propellant and a product, but is particularly suited to mixtures in which the constituents react with each other and must therefore be maintained separately until actual use.

The first constituent can suitably be the product to be dispersed or more preferably, a component of a reactive mixture. The first constituent may be a single component or more preferably, a mixture of more than one ingredient itself.

Preferably, the further constituent is a further component of a reactive mixture. As with the first constituent, the further constituent may be a single component or more preferably, a mixture of more than one ingredient itself. It could be a spreading aid or a finishing product.

The container closure 37 is adapted to allow mixing of the first constituent and a further constituent.

The fluid opening 38 is associated with the mixing valve 40. The mixing valve 40 is adapted to substantially seal the reservoir 39 in a first position and allow the further constituent to flow in a second position. The mixing valve 40 is also capable of adjustment to adjust the rate at which the further constituent flows from the reservoir 39.

The container closure 37 is at least partially see-through particularly in the region of the reservoir 39 containing the further constituent, in order to ascertain the amount of further constituent remaining in the reservoir 39.

The two constituents will mix in a turbulent manner and the mixing will be substantially instantaneous and means for preventing backflow, such as a non-return valve 41 is provided.

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A spray applicator for containing, mixing and releasing constituents of a reactive mixture, the applicator having
i. a first containing portion for containing a first constituent of the mixture; and
ii. at least one second containing portion for releasably containing a further constituent of the mixture, and
iii. an expulsion member for forcibly expelling the further constituent from the at least one second containing portion,
wherein each at least one second containing portion is operable between a first, unmixed condition in which the second constituent is retained separately from the first constituent and a second mixing condition in which the expulsion member is manipulated to release and forcibly expel the second constituent from the second containing portion to mix with the first constituent.

2. A spray applicator according to claim 1 further comprising an opening provided in a lower portion of the container and an activation means for moving the second containing portion between the first, unmixed condition in which the second constituent is retained separately from the first constituent and the second mixing condition.

3. A spray applicator according to claim 1 wherein the first containing portion is a pressurised can.

4. A spray applicator according to claim 3 wherein the second containing portion is located toward a lower portion or bottom of the pressurised can.

5. A spray applicator according to claim 1 wherein the second containing portion is a pouch or sac and is located abutting or resting against the bottom of the can.

6. A spray applicator according to claim 5 wherein the bag or sac second containing portion is rupturable to release the further constituent.

7. A spray applicator according to claim 6 wherein the expulsion member is associated with the activation means to move the expulsion member between a first condition in which the expulsion member is spaced from the bottom of the can, with the pouch or sac between the expulsion member and the bottom of the can, and a second condition in which the expulsion member is forced toward the bottom of the can, with the pouch or sac between the expulsion member, forcing the expulsion of the further constituent from the pouch or sac.

8. A spray applicator according to claim 7 wherein the activation means includes the expulsion member having a threaded projecting portion extending into the bottom of the can and rotation of the activation means moves the expulsion member between the first and second conditions.

9. A spray applicator having,
i. at least one container for containing at least one fluid to be sprayed, one of the containers having an internal agitation means to agitate the at least one fluid, and
ii. drive means separate from but engageable with the agitation means, the drive means adapted to engage the agitation means magnetically to drive the agitation means within the container.

10. A spray applicator for containing, mixing and releasing constituents of a reactive mixture, the applicator having
i. a container for containing a first constituent of the mixture;
ii. activation means to release the first constituent from the container;
iii. a container closure engageable with the container, the container closure comprising
a. a fluid opening through which fluid can flow, the fluid opening in fluid communication with the container,
b. at least one reservoir for containing a further constituent in fluid communication with the fluid opening, and
c. a mixing valve to control the flow of the further constituent from the at least one reservoir,
wherein upon operation of the activation means the further constituent is drawn from the at least one reservoir by the flow of the first constituent and the further constituent mixes with the first constituent, prior to exiting the container closure.
